(19) United States
(12) Patent Application Publication
(10) Pub. No.: US 2013/0013404 A1
(43) Pub. Date: Jan. 10, 2013

(54) SYSTEM AND METHOD FOR DISTRIBUTION OF DIGITAL OFFERS

(75) Inventors: John Suprock, Hinsdale, IL (US); Lawrence Bergenfield, Las Vegas, NV (US); Matthew Dailey, Westerville, OH (US)

(73) Assignee: MAGNETIFY CORPORATION, Las Vegas, NV (US)

(21) Appl. No.: 13/533,575

(22) Filed: Jun. 26, 2012

Related U.S. Application Data
(60) Provisional application No. 61/506,128, filed on Jul. 10, 2011.
(60) Provisional application No. 61/506,266, filed on Jul. 11, 2011.
(60) Provisional application No. 61/610,940, filed on Mar. 14, 2012.

(51) Int. Cl. G06Q 30/02

(52) U.S. Cl. 705/14.53

(57) ABSTRACT

Described herein are systems and methods for distributing digital offers to a consumer. The consumer may receive and select offers from brands and retailers, share these offers, and redeem these offers through the use of their connected consumer device.

### CLAIM OF PRIORITY

This application claims the benefit of priority to the following applications which are each herein incorporated by reference:
U.S. Provisional Patent Application No. 61/506,128, titled “SYSTEM AND METHOD FOR OBTAINING INCENTIVES FOR USE BY CONSUMERS AT RETAILER POINT OF SALE”, filed Jul. 10, 2011;
U.S. Provisional Patent Application No. 61/506,266, titled “SYSTEM AND METHOD FOR DISTRIBUTION OF DIGITAL LOYALTY OFFERS”, filed Jul. 11, 2011; and
U.S. Provisional Patent Application No. 61/610,940, titled “SYSTEM AND METHOD FOR DISTRIBUTION OF DIGITAL OFFERS”, filed Mar. 14, 2012.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present invention is in the technical field of relational cloud data, analytics, learning, and artificial intelligence.

### SUMMARY

Embodiments of the invention establish processes and procedures whereby Digital and Physical Markets are bridged through connections and or recognized through a purchasing event. These business fields are today described as Social and Mobile Retail Marketing in relation to measurement at cash registers and or a point of recognition or redemption.

Embodiments of the invention employ weighted customizable categorical metrics to each of the below areas that provide functional behavioral data enabling through: (1) connecting, integrating, capturing and indexing an individuals social media behavioral data (and their networks behavior); (2) connectivity, integration, capturing and indexing individual behavioral data (and their networks' behavior) in relation to Point of Intent computer software (such as an application or connectivity within) to a Connected Consumer Device (connected through Internet protocol such as a smartphone, tablet, set top box, automobile, etc.); and (3) connectivity, integration, capturing and indexing data from a Consumer prompted Point of Recognition (redeemed, benefited and or monetized at a physical point of sale (such as a cash register within a physical retail store).

The above three databases are thereafter measured through a relational database described as “Relational Content” which indexes behavioral data from social, to Point of Intent to Point of Recognition with weighted customizable categorical acquisition, registration, measurement and indexing individual and network metrics.

The corresponding data of each individual database or through “Relational Context” is intended to deliver an individual more personalized desired content that is funneled by and through a Consumer's digital and physical behaviors.

Embodiments of the invention employ Consumer prompted discovery and acceptance or rejection of queried content. If accepted by the Consumer, the appropriate social media Fan, Group, Brand, and or Association page is automatically shown an expressed affinity.

This prompts analyzed individual (and network) expressed affinity, dislikes, and gauges the strength of brand affinities in direct connection to and integrated throughout social media brand, group, product, and association pages.

A Consumer Facing Content Management System integrates and analyzes relational computation clouds that include: (1) one or more social media websites, (2) one or more connected devices (through Internet protocol such as mobile phones, tablets, computers, set-top boxes, and other such computing devices); (3) electronic point of sales systems; and (4) in connection to an individual Consumer and correlations between the Consumer's network.

Consumers engage with content, which may be described as static, video, and or aggregated and or related information. Rational Product offers are submitted for the Consumer to review, accept or reject, related to content that the Consumer views or queries the system to deliver. Offers that a Consumer may receive in connection to this content will include aggregated product offers along with personalized offers based on ones action and the actions they inspire others to take within their social network. Redemption of these offers is enabled through Connected Consumer Devices.

Consumers have the ability to share content and redeem offers through software that rests on their Connected Consumer Device or directly through the Social Media Sites so long as they complete registration or ‘opt-in’. Sharing may occur within social networks as group or to an individual; along with, outside of the social network such as email, text, or multi media messages, and through direct techniques using Internet protocol. Such registration requires the Consumer to download the appropriate software or access by means of a web browser and authenticating their identity through their social media username and password. This action builds and analyzes relational data from and throughout a Consumer's social network to the Connected Consumer Devices to the relational database for indexing and analysis.

Connected Consumer Devices exemplify a Consumer's ‘Point of Intent’ through which, the system servers verify the authentication data while automating relational cloud data between Consumers' social network locations and behavior, specifically, predictive analysis regarding actual purchase data, obtained through one or more Connected Consumer Devices such as mobile phones, tablets, computers, set-top boxes and televisions, that are activated by integration of and through Consumer accepted content enabled through Fan, Brand, Group, Association, or other type of pages such as social media destinations. This connectivity enables stakeholders such as Retailers, Brands, and service providers to wirelessly, securely, and privately deliver personalized offers which will invariably enable smarter product, brand, group or association affinities through hyperlocal social networks based on behavioral, network and purchase data and relationships: (1) From a social media website, upon a Consumer demonstrating affinity for a social media Fan, Brand, Group, Association or other type of pages (social media destination) that endeavors to build product, brand, group or association affinity; and (2) from software application, review and acceptance of content and offers associated to a Consumer's Content Management System (shopping list) which automates integration into social media Fan, Brand, Group, Association or other type of pages (social media destination) that endeavors to build stronger and transparent product, brand, group or association affinities.

When a Consumer takes an action at their point of intent: to create a shopping list, to shop and redeem offers, to accept an offer, to share an offer with an individual or a group within their social network, to view content, streaming video content, or share links to static or video content, to demonstrate affinity for a product, brand, group, association via the application on the Connected Consumer Device, these actions will be registered in relational and offer databases for indexing and analysis. The resulting aggregated data will increase the value of select offers from the Brand and Retailers. Participating Brands, Retailers, and other service providers will be able to independently control and manage in real-time the scope, frequency, and qualifications for select offers.

The example systems that inter-operate to optimize the value of Relevant Content and Digital Offers for Consumers include: (1) Connected Consumer Devices that provide wired or wireless remote communication with other wired or wireless remote computer systems such as a television, television equipped with a Set-Top Box, or a personal computer with other remote computer systems such as a mobile device, 4th screen device or tablet, or any other device that may be connected to Internet protocol such as an automobile; (2) the Connected Consumer Device integrates and communicates with an Offer Management Application to coordinate data exchange between the Consumer, integrated Social Media Sites, and the Offer Management Server; (3) independent Social Media Sites that offer Consumers, Retailers, and Brands media to offer information, content, and other media of value to Consumers; and (4) the Offer Management Server which co-ordinates the information gathered from the Offer Management Application, Social Media Site, and the Connected Consumer Device.

Customized or personalized offers created for Consumers are Digital Loyalty Offers, which are defined as an offer of discount or other value where the value or discount can be adjusted in value for a single Consumer based upon their profile, previous activities, and these relationships in association to their networks behavior from or through social to Connected Consumer Device to transaction and or measureable event. These Digital Loyalty Offers are downloadable to an Offer Management Application, which is a software application resident on a Consumer's Connected Consumer Device. The Offer Management Application facilitates the redemption of Digital Offers on behalf of the Consumer.

The Offer Management Application also provides the Consumer the ability to manage and maintain multiple shopping lists. Customers can specify which products should be displayed while shopping at particular locations; manage a central list of all items purchased through Retailers and other personal locations; and share Digital Offers, shopping lists, and shopping activity through Social Media Sites. This information will be stored as part of indexed data around the Consumer's social, mobile and physical behavior.

The Offer Management Server maintains indexed data sets of Consumers and performs any network searching, database interaction, and Consumer activity related to the Consumer's presence, selections, and demographics. Consumer presence is determined through: scope of their social network, influence on their social network, and communication activity; frequency of application activity; shopping at Retail locations; interacting with Retail and Brand rich media; and other activities that would describe the persona of the Consumer.

Consumer choices are determined through their selection of products and Digital Offers through the Offer Management Application and their interaction with Retail and Brand social media at the product and location level.

Consumer demographics are determined through characterizations of available data through Social Media Sites and any information the Consumer chooses to provide to the Offer Management Application. Such demographic data shall include the inferred demographics of the customer which could include: demographics calculated on the geographic location of application usage to determine core location, entertainment, and working location; estimates of household income based upon geographic information; number of contacts and the demographics of those contacts; and other data elements including gender, age, dependants, animals, and participation in regional events.

Key metrics for all social, mobile and redemption data will be established by and drawn from Consumer opt-in and Consumer behaviors within their active use of the Offer Management Application, and shall include but not be limited to: (1) Consumer Acquisition Metric-time, location, demographic, etc.; (2) Consumer Registration Metric which includes significant others and others within their network; (3) Measurement Metric—social to mobile actions, physical world actions, shopping list actions, acceptance, content viewed, exchanges during-list building, and other activity actions. (4) Indexing Metric—items purchased in association with social network behavior, impact, virality, and other relational or positional data.

All data originating from either social, mobile and or redemption data is tagged and put into indexing databases and the data provided through social networks includes all information made available and allowed by the Consumer through public API's.

Consumer Metrics will allow Brand, Retailer, and service providers who use this system to pre-determine weighting for each metric, enabling them to optimize use of the Offer Management Server and to define and determine the prioritization and formulation of offers to the Consumer as they deem appropriate.

### BRIEF DESCRIPTION OF THE FIGURES

FIG. 1 is a flow chart diagram in accordance with an embodiment of the present invention;

FIGS. 2A-2I represent a schematic block diagram that shows the communication between elements of an embodiment of the present invention beneficial for Consumer interaction with an embodiment of the present invention;

FIG. 3 is a schematic block diagram that shows the communication between the elements of an embodiment of the present invention beneficial for Brand, Retailer, and affiliate interaction with an embodiment of the present invention; and

FIG. 4 is a schematic block diagram that shows the analysis of the Consumer activity, in accordance with an embodiment of the invention.

### DETAILED DESCRIPTION OF THE INVENTION

In the following description, the invention will be illustrated by way of example and not by way of limitation in the figures of the accompanying drawings. References to various embodiments in this disclosure are not necessarily to the same embodiment, and such references mean at least one. While specific implementations are discussed, it is understood that this is provided for illustrative purposes only. A person skilled in the relevant art will recognize that other components and configurations may be used without departing from the scope and spirit of the invention.

Furthermore, in certain instances, numerous specific details will be set forth to provide a thorough description of the invention. However, it will be apparent to those skilled in the art that the invention may be practiced without these specific details. In other instances, well-known features have not been described in as much detail so as not to obscure the invention.

Described herein are systems and methods for distributing Digital Offers to a Consumer, where the Consumer may receive and select offers from Brands and Retailers, share these offers, and redeem these offers through the use of their Connected Consumer Device.

Offers created are Digital Offers, which are defined as an offer of discount or other value where the value or discount can be adjusted in value for a single Consumer based upon their profile and previous activity. These Digital Offers are downloadable to an Offer Management Application, which is a software application resident on a Consumer's Connected Consumer Device. The Offer Management Application facilitates the redemption of the Digital Offer on behalf of the Consumer.

The Consumer has multiple methods to accept a Digital Offer. They may begin by using their Connected Consumer Device to scan a barcode, send a text message to a short code, visit a Social Media Site, or send an Internet message. Each of these activities will enable a visit to a Social Media Site where a Digital Offer is available.

Should the Consumer ask for the Digital Offer, the Social Media Site will send the request to an Offer Management Server, which will use all of the information available to it to determine the value of the Digital Offer for that specific Consumer. This information may include if a Consumer should subscribe to content; choose products and identify them as preferred; express an affinity to a Retailer, Brand, or product; purchase a product; play a game or enter a sweepstake or contest and any such activity that may be discoverable by or communicated to the Offer Management Server.

Should the Consumer accept the Digital Offer, the Offer Management Server will first determine if the Consumer is using an application to manage the Digital Offers on their Connected Consumer Device. If not, the Consumer first agrees to load the Offer Management Application on their Connected Consumer Device. Subsequently, the Consumer will be able to download the Offer Management Application from a software site appropriate to the Consumer's Connected Consumer Device. Once the Consumer enables the Offer Management Application, they will complete the registration of the Offer Management Application. Registration will include synchronization of the Social Media Site information with the Offer Management Server including Consumer identification and password; preferences by the Consumer; and the opt-in or consent of the Consumer to permit the Offer Management Server access to activity and information required to determine offer value and any other offers.

Once registration is complete or if the Consumer accepts a Digital Offer while the Offer Management Application is present on their Connected Consumer Device, the Offer Management Server will populate the Offer Management Application with the accepted Digital Offer along with any other Digital Offer the Offer Management Server has determined are appropriate for that Consumer.

Should the Consumer choose to share the Digital Offer they may use SMS; synchronize their Offer Management Application with another selected Consumer; send by email a link to the Digital Offer; or post the link to an Offer Management Application on a website. The Offer Management Application will notify the Offer Management Server of the Consumer activity and the activity of the links sent or posted by the Consumer where the sharing activity will be included in the customer profile.

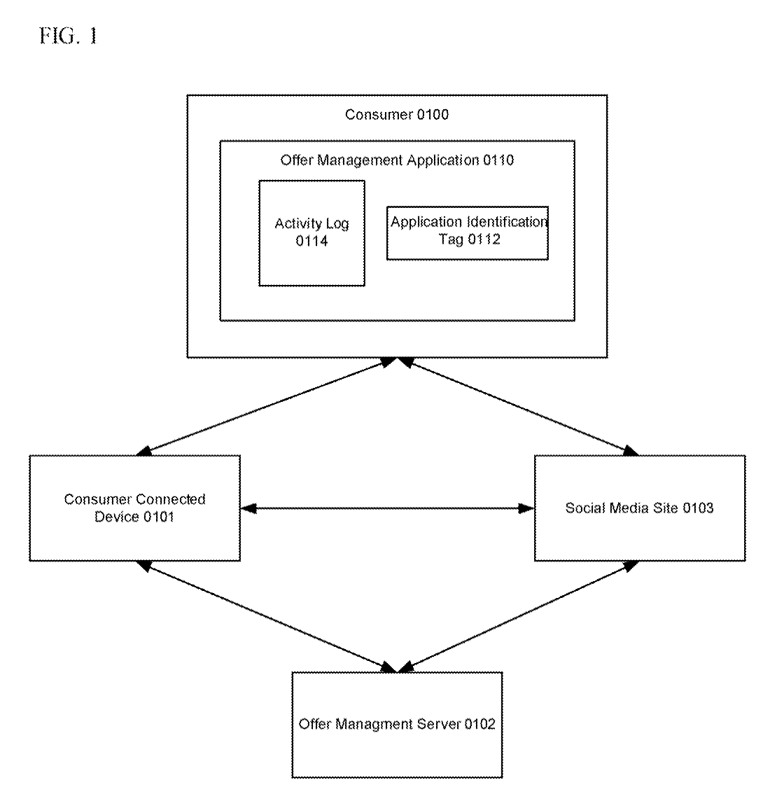

FIG. 1 shows the elements beneficial for the Consumer to receive and select offers from Brands and Retailers, share these offers, and redeem these offer through the use of their Connected Consumer Device, mobile web, or, Internet.

FIG. 1 shows item 0100 which represents the Consumer. The Consumer is the person who is shopping and seeking discounts and offer, discussing their experience with products and companies, and may choose to share offers and information. The Consumer will interact with both the Connected Consumer Device, which is identified as item 0101 in FIG. 1, and the Social Media Site, which is identified as item 0103 in FIG. 1.

FIG. 1 also shows item 0101 which represents the Connected Consumer Device. The Connected Consumer Device is a computing device with an Internet Protocol Address and is able to access the Internet using wireless or wired communication technology. The Connected Consumer Device may be a mobile phone, mobile device, computer, tablet, other handheld computing device, desktop or laptop computing device, set-top box, TV set-top box, television, game console, automobile, airplane or boat with a computing device, or any other computing device of like ability. The Connected Consumer Device is capable of running an application which provides the Consumer the ability to browse Social Media Sites and to load an Offer Management Application 0110. The Offer Management Application 0110, which is resident on the Connected Consumer Device, can communicate the items identification to the Offer Management Server, which is shown as item 0102 in FIG. 1, as well as the Social Media Sites that are collectively shown as item 0103 in FIG. 1. The offer management includes an application identification tag 0112 and an activity log 0114. The application identification tag uniquely identifies the offer management application, and the activity log includes one or more viewed items. The Offer Management Application has the ability to enable the Consumer to redeem the Digital Offer at the Point of Sale at a Retailer location.

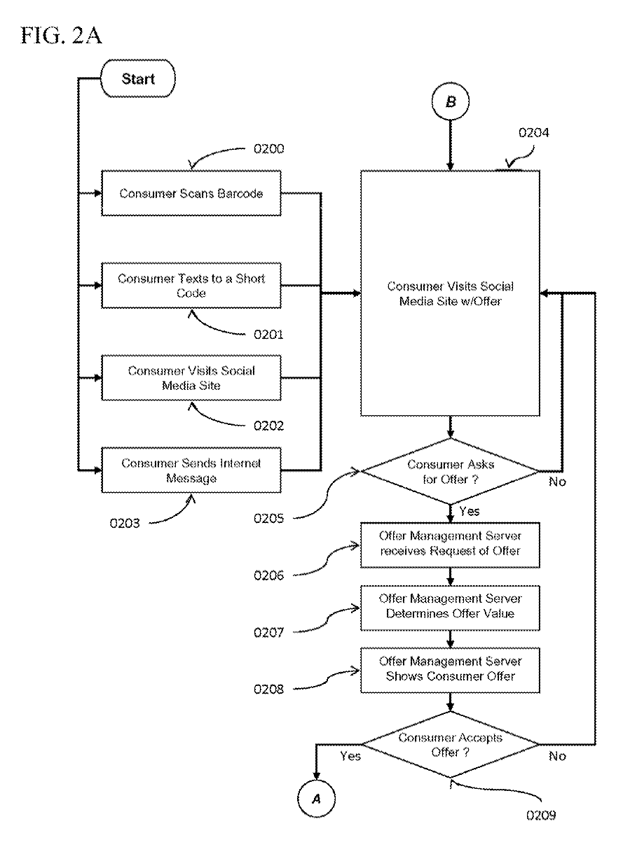

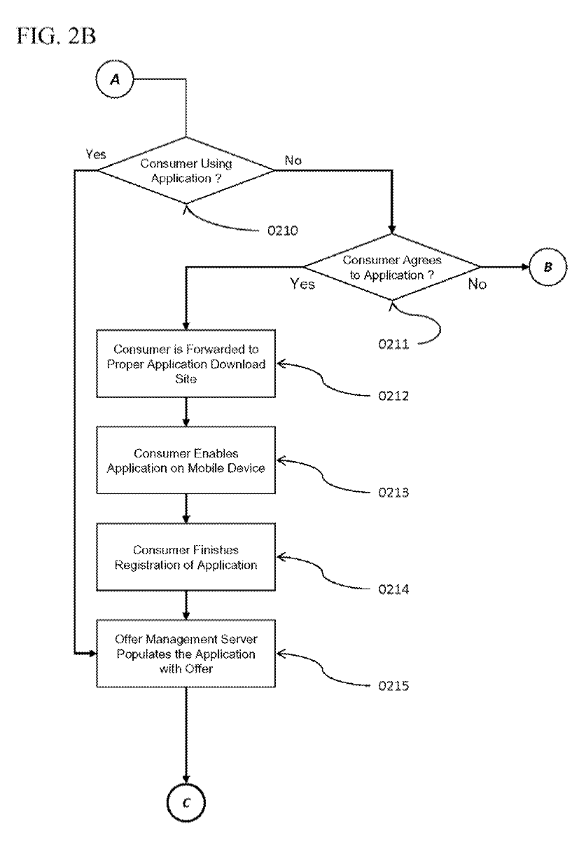

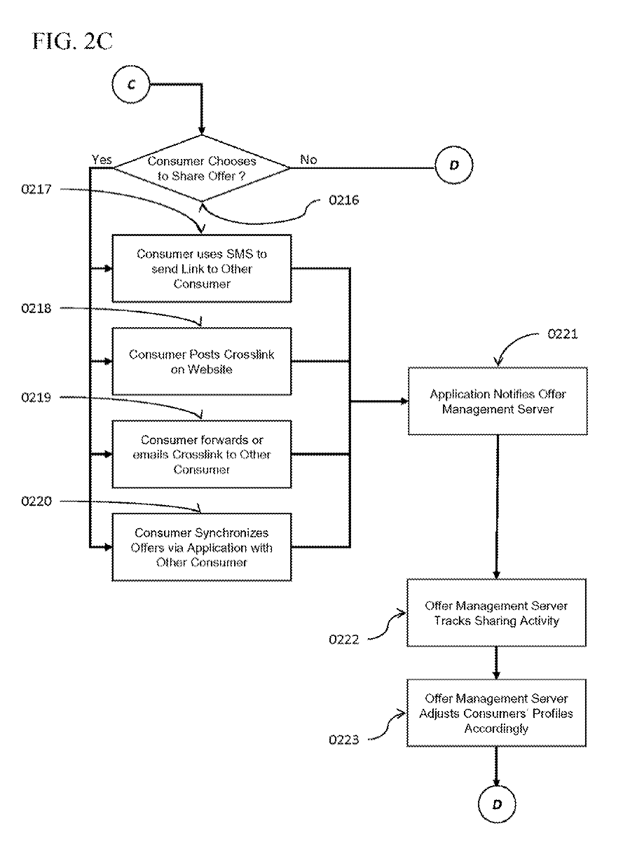

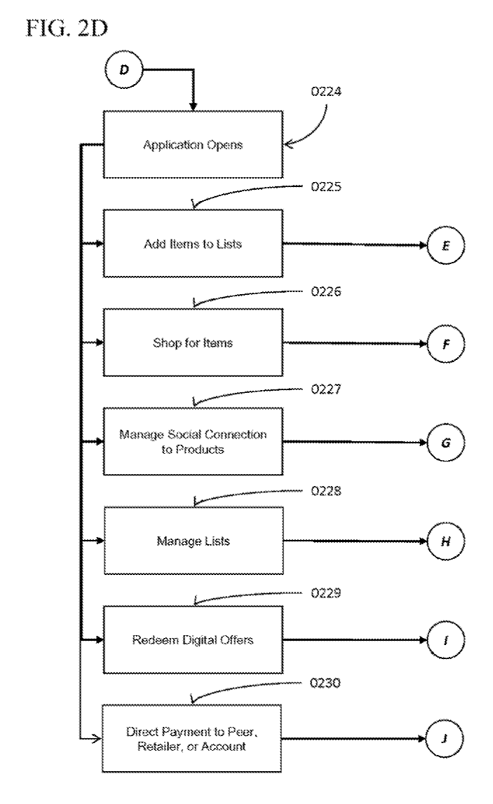

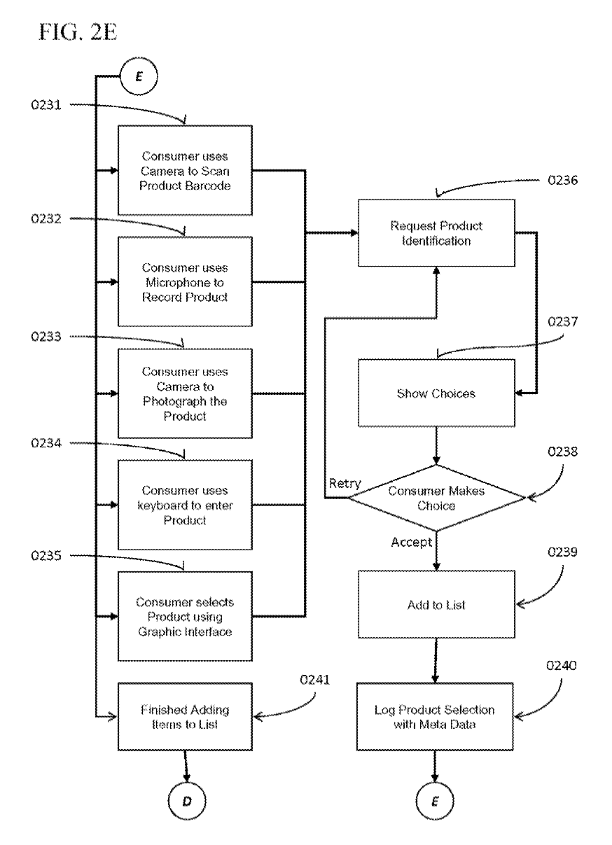

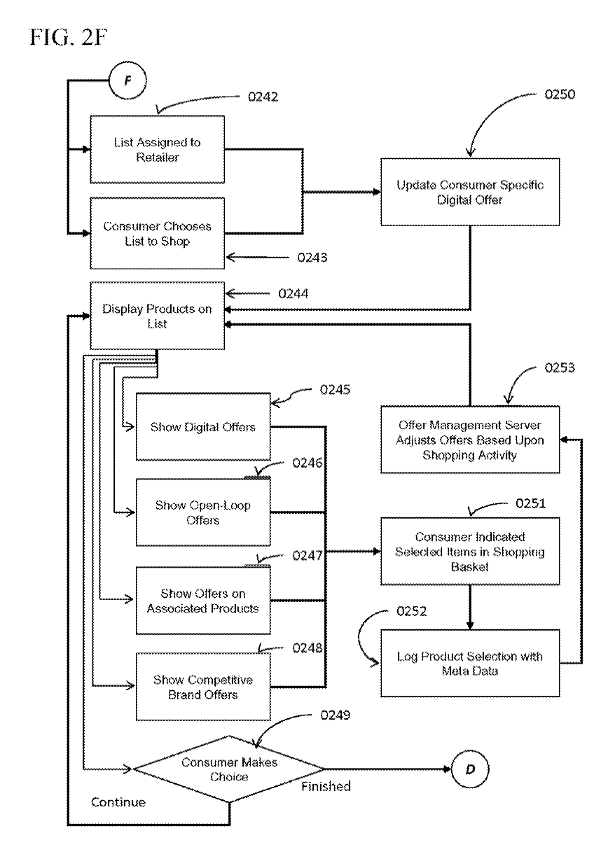

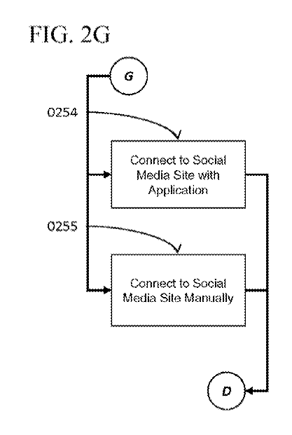

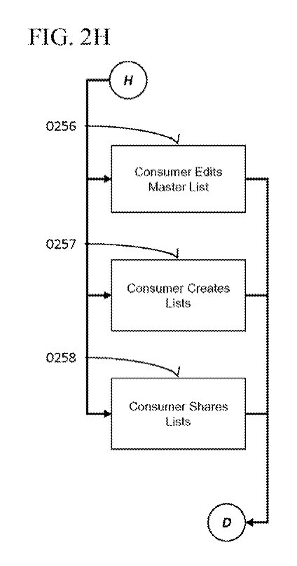

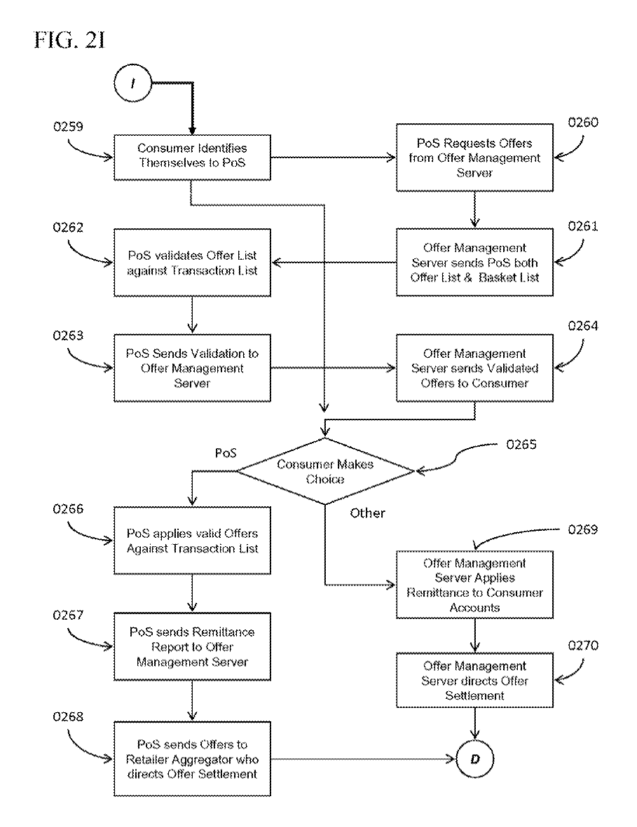

Offer Management Server 0102, in FIG. 1, contains a data base of shopping information collected by (1) the Offer Management Application, which includes Offers prepared for Consumers by Brands, Retailers, and marketing affiliate agents, (2) predictive social behavior calculated on Consumer activity, (3) remarketability of indexed Consumer data analytics, and (4) Offer selection algorithms which operate under rules established by the Offer owner. These rules could include minimum and maximum redemption offers, time, offer duration, location valid, specific retailer valid locations, and other terms and conditions as determined important by the offer owner. As the Consumer makes selections and adds them to the Offer Management Application, the Offer Management Server will make offers which are relative to the items chosen to the Consumer. Should there be items in the Consumer basket that are not on the shopping list, the Offer Management Server will determine which offers the Consumer may be eligible and add these offers to the Offer Management Application automatically for presentation to the Consumer. The Offer Management Server can communicate to the Social Media Site, which is shown as item 0103 in FIG. 1 and to the Connected Consumer Device, which is shown as item 0101 in FIG. 2A. It is to be understood that the Offer Management Server 0102 can be a local server and/or a remote server and/or a server farm. Further Offer Management Server 0102 can be scalable and available as cloud based web services, web based hosting and/or cloud servers.

Social Media Site 0103 is controlled by a Consumer as well as those produced by a Retailer, Brand, or as another Affinity Site. The Consumer leverages connectivity between one or more Social Media Sites to share content and Digital Loyalty Offers. The Social Media Site may make available to Consumers Digital Offers. Digital Offers are offers of value or discount that can be redeemed by the use of a Connected Consumer Device at the Retail Point of Sale. Consumers can interact with these sites to indicate loyalty to the Retailer or Brand through the appropriate mechanism for each site. The Consumer has the option of using the Social Media Site credentials to be shared with the Offer Management Application and the option of the Offer Management Application and Offer Management Server to collect affinity selections by the Consumer from the Social Media Site. The Consumer has the option of communicating to the Social Media Site through any internet enabled media and is not limited to the Connected Consumer Device. The Social Media Site will interact with both the Connected Consumer Device, which is identified as item 0101 in FIG. 1; the Offer Management Server, which is identified as item 0102 in FIG. 1, and through the Consumer, identified as item 0100 in FIG. 1.

FIGS. 2A-2I show the sequence of events beneficial for the Consumer to manage the reception of Digital Offers and the Brands and Retailers to distribute Digital Offers.

FIG. 2A shows a process 0200 indicated as ‘Consumer Scans Barcode’. To discover a Digital Offer, a Consumer may choose to use their Connected Consumer Device to scan a barcode, a QR code, a one dimensional, two dimensional or three dimensional code, a proprietary code, an open code, a water mark, a visual code and/or an audio code, of any configuration. The software resident on the Connected Consumer Device will translate the barcode into a website which will connect the Consumer to a Social Media Site which has available Digital Offers.

FIG. 2A also shows a process 0201 indicated as ‘Consumer Texts to a Short Code’. To discover a Digital Offer, a Consumer may choose to use to send a text message to a short code. The software resident on the Connected Consumer Device will allow the Consumer receive a reply text message which will provide a URL or Hyperlink which will allow a Consumer to visit a Social Media Site or to directly download the Offer Management Application for that Connected Consumer Device

FIG. 2A also shows a process 0202 indicated as ‘Consumer Visits Social Media Site’. To discover a Digital Offer, a Consumer may choose to use the internal browser software of the Connected Consumer Device, a browser on a computing device of any other type, or any other appropriate technology able to render Social Media Sites. While interacting with the Social Media Sites, the Consumer may subscribe to content; choose products and identify them has preferred; express an affinity to a Retailer, Brand, or product; purchase a product; or play a game or enter a sweepstake or contest. All such activity will be discoverable by or communicated to the Offer Management Server.

FIG. 2A shows a process 0203 indicated as ‘Consumer Sends Internet Message’. Within the Offer Management Application, there is a mechanism to inquire of any Digital Offers available. These messages can be email or any form of real-time direct text-based chatting communication in push-mode between two or more people using personal computers or other devices, along with shared clients. The Offer Management Server can redirect the message to a Social Media Site through choice declared by the Consumer.

FIG. 2A shows a process 0204 indicated as ‘Consumer Visits Social Media Site w/Offer’. The Social Media Site can be either managed directly through communication with the Offer Management Server or by either the Retailer or Brand. The operator of the Social Media site can, through the Offer Management Server, establish a series of offers based on the product; demographics available of the Consumer which can include prior history, location, income, gender and other available demographic data; and further meta-data established from the Consumer history from the Offer Management Application.

FIG. 2A shows a process 0205 indicated as ‘Consumer Asks for Offer’. The Consumer makes a determination by either of three choices, accepting the Digital Offer, rejecting the Digital Offer, or taking no action. Should the Consumer ask for the Digital Offer, the Social Media Site will forward the request to process 0206 indicated as Offer Management Server Receives Request of Offer. Should the Consumer decline the offer, the Social Media site may either show another offer or show any other content. Should the Consumer choose to take no action, the session timer will expire, and such data will be collected and sent to the Offer Management Server. In all cases; accept, decline, or no action; the Social Media Site will provide such choices to the Offer Management Server along with as much transaction related data as available.

FIG. 2A shows a process 0206 indicated as ‘Offer Management Server receives Request of Offer’. Once receiving the Digital Offer request, the Offer Management Server will queue the process. The Offer Management Server will use information received from the Social Media Site to determine the identification of the Consumer.

FIG. 2A shows a process 0207 indicated as ‘Offer Management Server Determines Offer Value’. The Offer Management Server may use the non-personal identifiable information submitted by the Social Media Site; the purchase history; categorical, similar, or same products where the Consumer has subscribed, chosen, shown affinity, or purchased; complementary, competitive, or specific Digital Offers previously accepted; private label Digital Offers selected; history of sharing of Digital Offers; predictive analytics; results of operant conditioning; and Consumer location.

FIG. 2A shows a process 0208 indicated as ‘Offer Management Server Shows Consumer Offer’. Based upon the results of the process, the Offer Management Server may adjust the Digital Offer based upon rules set by the Retailer, Brand, or other offering agency. The Digital Offer then is presented to the Consumer for their confirmation of acceptance.

FIG. 2A shows a process 0209 indicated as ‘Consumer Accepts Offer’. Should the Consumer decline the Digital Offer, the Offer Management Server will redirect the Consumer to the Social Media Site. Else, the Offer Management Server will proceed to the next process, shown as 0210 in FIG. 2B.

FIG. 2B shows a process 0210 indicated as ‘Consumer Using Application’. The Offer Management Server will have to determine if the Consumer is using the Offer Management Application. If the Consumer is using the Offer Management Application, the Offer Management Server will proceed to process 0215 as shown in FIG. 2B. If not, the Offer Management Server will proceed to process 0211 as shown in FIG. 2B.

FIG. 2B shows a process 0211 indicated as ‘Consumer Agrees to Application’. If the Consumer is not using the Offer Management Application, the Consumer Opts-in to the Offer Management Application and accept the terms and condition of the use of the application. If the Consumer declines the application, the Offer Management Server will redirect the Consumer to the Social Media Site. Should the Consumer accept the application, the Officer Server will proceed to process 0212 as shown in FIG. 2B.

FIG. 2B shows a process 0212 indicated as ‘Consumer is Forwarded to Proper Application Download Site’. Based upon meta-information received from the Connected Consumer Device, or from information specified by the Consumer during the acceptance process, the Consumer will be forwarded to the proper website so that the Consumer may download the Offer Management Application compatible with their Connected Consumer Device.

FIG. 2B shows a process 0213 indicated as ‘Consumer Enables Application on Connected Consumer Device’. The Consumer can enable the Offer Management Application on the Connected Consumer Device and confirm that it operates properly.

FIG. 2B shows a process 0214 indicated as ‘Consumer Finishes Registration of Application’. Registration on the Offer Management Application requires authentication of the Consumer identity by adding information from the Social Media Site which includes identity credentials, preferential limits expressed by Consumer for sharing information based upon specific Social Media Site privacy settings and consent policies, and the Opt-in or consent of the Consumer to permit the Offer Management Server access to activity and information required to determine Offer Value and any other Offer values.

FIG. 2B shows a process 0215 indicated as ‘Offer Management Server Populates the Application with Offer’. Once the Offer Management Application is enabled, the Offer Management Server will populate the Offer Management Application with the Digital Offer.

FIG. 2C shows a process 0216 indicated as ‘Consumer Chooses to Share Offer’. Once the Consumer has the Digital Offer populated in their Offer Management Application, they may choose to share the Digital Offer with other Consumers. There choice of sharing will be under control of the Offer Management Application as processes 0217, 0218, 0219, and 0210 as shown in FIG. 2C.

FIG. 2C shows a process 0217 indicated as ‘Consumer uses SMS to send Link to Other Consumer’. Should the Consumer choose to send a Digital Offer as a text message to another Consumer, the Offer Management Application will assist the sending of a text message to a another Consumer. The other Consumer will receive a message as if they were participating in process 0201 as shown in FIG. 2A. The other Consumer will enter the process as if they themselves had texted to a short code.

FIG. 2C shows a process 0218 indicated as ‘Consumer Posts Crosslink on Website’. The Offer Management Application will facilitate the posting of a cross-link by the Consumer to another website. The Offer Management Application will communicate with the Offer Management Server which will provide the Consumer with a URL that will direct any other Consumer to process 0205 as shown in FIG. 2A. Communications, for example, from a desktop or laptop can be from a web browser to a web server (a client-server configuration). Communications from for example a mobile device such as a mobile phone can be from a mobile application (app) to a mobile application (app) or from a web browser to a mobile application (app).

FIG. 2C shows a process 0219 indicated as ‘Consumer forwards or emails Crosslink to Other Consumer’. The Offer Management Application will facilitate the posting of a cross-link by the Consumer inside of an email. The Offer Management Application will communicate with the Offer Management Server which will provide the Consumer with a URL that will direct any other Consumer to process 0205 as shown in FIG. 2A.

FIG. 2C shows a process 0220 indicated as ‘Consumer Synchronizes Offers via Application with Other Consumer’. The Offer Management Application will synchronize Digital Offer between the Consumer and any other Consumer they have selected. The synchronization will be coordinated by the Offer Management Server to make sure that Offer Management Application has an equivalent Digital Offer.

FIG. 2C shows a process 0221 indicated as ‘Application Notifies Offer Management Server’. All information regarding sharing will be sent by the Offer Management Application to the Offer Management Server.

FIG. 2C shows a process 0222 indicated as ‘Offer Management Server Tracks Sharing Activity’. All sharing information and transaction information will be included in the Consumer profile. Using the sharing and transaction information, the Offer Management Server will adjust multiple Consumer profiles accordingly, and such information will be used to determine the value of Digital Offers provided to Consumers.

FIG. 2C shows a process 0223 indicated as ‘Offer Management Server Adjusts Consumers’ Profiles Accordingly'. Based upon the sharing activity of the Consumer and any stored information about the Consumer, Brand, Retailer, and Recipients of Consumer sharing activity, the Offer Management Server will adjust the data with information such as quantity, type, Brand, Retailer, and other factors such as quality. From this information, the Offer Management Server will adjust the Consumer Profile. This Consumer Profile will be used to determine the Digital Offers the Consumer will be offered on behalf of the Retailers and Brands.

FIG. 2D shows a process 0224 indicated as ‘Application Opens’. When the Offer Management Application (referenced as “Application” in the process) opens, it makes a location check to determine as exactly as possible the geographical coordinates of the Consumer. Once the coordinates are determined, the Offer Management Application will compare known locations against a data base of store locations. If a location is where the Consumer shops or if it is a shopping location for other Consumers, the Offer Management Application will ask the Consumer if they are ready to shop at this location; if the Consumer provides a positive acknowledgement, the Offer Management Application will assume the Consumer is ready to shop and will automatically begin process 0226 ‘Shop for Items’ as shown on FIG. 2D; if the Consumer provides a negative acknowledgement, the Offer Management Application will open a menu list where the Consumer may choose any process 0225, 0226, 0227, 0228, or 0229 as shown on FIG. 2D. If a location is where the Consumer is known to build shopping lists, the Offer Management Application will ask the Consumer if they are ready to make a list at this location; if the Consumer provides a positive acknowledgement, the Offer Management Application will assume the Consumer is ready to make a list and will automatically begin process 0225 ‘Add Items to Lists’ as shown on FIG. 2D; if the Consumer provides a negative acknowledgement, the Offer Management Application will open a menu list where the Consumer may choose any process 0225, 0226, 0227, 0228, or 0229 as shown on FIG. 2D. The Offer Management Application will also record meta-data relative to the location, dwell time, and other information about the geo-location information where the Consumer decides their activity.

FIG. 2D shows a process 0225 indicated as ‘Add Items to Lists’. If the location is known in the profile of the Consumer as a location where lists are compiled, the Offer Management Application will be ready to build a list, and will open to a selection menu where a Consumer may choose any process 0231, 0232, 0233, 0234, or 0235 as shown on FIG. 2e. The Offer Management Application will also record meta-data relative to the location, dwell time, and other information about the geo-location information where the Consumer chooses to add items to a shopping list.

FIG. 2D shows a process 0226 indicated as ‘Shop for Items’. Should a Consumer choose ‘Shop for Items’, either by menu selection or prompt, the Offer Management Application will show process 0243 on FIG. 2F and make a location check to determine as exactly as possible the geographical coordinates of the Consumer. Once the coordinates are determined, the Offer Management Application will compare known locations against a data base of store locations. If a location is where the Consumer shops or if it is a shopping location for other Consumers, the Offer Management Application will ask the Consumer if they are ready to shop at this location; if the Consumer provides a positive acknowledgement, the Offer Management Application will assume the Consumer is ready to shop; if the Consumer provides a negative acknowledgement, the Offer Management Application will open a menu list where the Consumer may choose any process 0225, 0226, 0227, 0228, or 0229 as shown on FIG. 2D.

FIG. 2D shows a process 0227 indicated as ‘Manage Social Connection’. This process will permit the Consumer to add, delete, change, and suspend various activities between the Offer Management Application and Social Media Sites. Activities will include but not be limited to controlling participation of the Offer Management Application with multiple Social Media Sites, access to information provided by Social Media Sites, how the Offer Management Application manages sharing of activity through the Social Media Sites, and the frequency, detail, and scope of sharing.

FIG. 2D shows a process 0228 indicated as ‘Manage Lists’. The Offer Management Application allows the Consumer to manage more than one list of items and associated Digital Offers. The Offer Management Application communicates with the Offer Management Server to create a Master List. This Master List contains all of the information the Consumer is willing to share with the Offer Management Application with regard to the items the Consumer purchases. Such information will include: the Retailer and its location, discount, stock keeping unit or any numbers or codes used to identify each unique product or item for sale in a store or other business, price paid, and descriptive qualities such as color, size, quantity, or weight; the Brand and the location or Retailer purchased from, any other information to uniquely identify the product; and all time elements such as date of purchase, dwell time, and duration between adding, selecting, and purchasing item.

Shorter lists can be constructed by selecting items from the Master List, and thereby building a new list. The Offer Management Application in coordination with the Offer Management Server will manage multiple lists.

Lists as well as items can be assigned to a Retailer. The Retailer identified could be one specific Retailer or one or more locations of a Retailer.

When examining an item on the Master List, a Consumer can see the history of the item purchase, showing a subset of all of the Master List Data. Such subset information would show the Retailer, price, quantity, and last purchase, but may also show more.

Consumers will have the ability to add, delete, change, and suspend items on the Master List. Deleting an item on the Master List will cause it to no longer be displayed by the Offer Management Application, Offer Management Server Portal, or Social Media Site, and it will no longer be used to calculate Digital Offers or the Consumer Profile.

FIG. 2D shows a process 0229 indicated as ‘Redeem Digital Offers’. Should a Consumer choose Redeem Digital Offers, either by menu selection or prompt, the Offer Management Application will show process 0259 on FIG. 2I

FIG. 2D shows a process 0230 indicated as ‘Direct Payment to Peer, Retailer, or Account’. Should a Consumer choose to redeem Digital Offers, the Customer will have a choice between several options for where the credit shall be applied: 1) a ‘Load to Card’ option where the credit will applied to a card, either loyalty or financial, known to the Retailer electronic point of sale system; 2) a financial network card such as a credit or debit card; or 3) a pre-paid card such as a gift-card, pre-paid financial network card, or other financial vehicle. This process will collect and set the Consumer choices for use as a state table for decision making processes by the Offer Management Application.

FIG. 2E shows series of processes that will provide the Consumer the ability to add items to the shopping list capability of the Offer Management Application. The Graphic Consumer Interface of the will provide the Consumer the five choices for identifying the products to be added to the list by providing the processes indicated as 231, 232, 233, 234, and 235. The Offer Management Application will retrieve and present a series of choices for the Consumer so that they can confirm their selection. The Offer Management Application will permit the Consumer to accept, reject, or start the entry process again.

FIG. 2E shows a process 0231 indicated as ‘Consumer uses Camera to Scan Product Barcode’. Should the Connected Consumer Device have a camera capable of reading barcodes, the Offer Management Application will use this hardware and software to decode barcodes and determine the unique identifier, internet address, stock keeping unit, text file, script or processing instructions, or any other barcode information. This decoded information will be forwarded to processes 0235 as shown on FIG. 2E.

FIG. 2E shows a process 0232 indicated as ‘Consumer uses Microphone to Record Product’. Should the Connected Consumer Device have a microphone capable of recording the Consumer's spoken voice, the Offer Management Application will use this hardware and software to convert the speech to text and determine the unique identifier, internet address, stock keeping unit, text file, script or processing instructions, or any other product information such as brand, size, description, quantity, category of product, product description, or any other Metadata that would permit the Offer Management Application to clearly identify the chosen product. This decoded information will be forwarded to processes 0236 ‘Request Product Identification’ as shown on FIG. 2E.

FIG. 2E shows a process 0233 indicated as ‘Consumer uses Camera to Photograph the Product’. Should the Connected Consumer Device have a camera capable of capturing images, the Offer Management Application will use this hardware and software to create a file compatible with an image recognition function and determine the unique identifier, internet address, stock keeping unit, text file, script or processing instructions, or any other barcode information. This decoded information will be forwarded to processes 0236 ‘Request Product Identification’ as shown on FIG. 2E.

FIG. 2E shows a process 0234 indicated as ‘Consumer uses keyboard to enter Product’. Should the Connected Consumer Device have a camera capable of reading barcodes, the Offer Management Application will use this hardware and software to decode barcodes and determine the unique identifier, internet address, stock keeping unit, text file, script or processing instructions, or any other barcode information. This decoded information will be forwarded to processes 0236 ‘Request Product Identification’ as shown on FIG. 2E.

FIG. 2E shows a process 0235 indicated as ‘Consumer selects Product using Graphic Interface’. Should the Connected Consumer Device have a camera capable of reading barcodes, the Offer Management Application will use this hardware and software to decode barcodes and determine the unique identifier, internet address, stock keeping unit, text file, script or processing instructions, or any other barcode information. This decoded information will be forwarded to processes 0236 ‘Request Product Identification’ as shown on FIG. 2E.

FIG. 2E shows a process 0236 indicated as ‘Request Product Identification’. The Offer Management Server will receive a formatted message from the Offer Management Application for requested information regarding the product. The Offer Management Server will use as much meta-data with regard to the geolocation of the Consumer, Retailer specific data, Brand specific date, Master List, identification numbers available to the Offer Management Server search engine, and a public search engine to select the most likely item that the Consumer has identified.

FIG. 2E shows a process 0237 indicated as ‘Show Choices’. The Offer Management Server will send a formatted message to the Offer Management Application with a subset of the available item information to allow the Consumer to positively identify the Item that they wish to add to the list.

FIG. 2E shows a process 0238 indicated as ‘Consumer Makes Choice’. Once the Consumer has decided that are being shown the desired Item, they may use any of the capabilities of the Connected Consumer Device including but not limited to the graphical interface, microphone, touch screen, or keyboard to make their selection.

FIG. 2E shows a process 0239 indicated as ‘Add to List’. The Offer Management Application will add the Item to both the current list, and to the Master List as an Item.

FIG. 2E shows a process 0240 indicated as log Product Selection with Meta Data'. The Offer Management Server will store the Product Information from the results of the process 0236 indicated as ‘Request Product Identification’ as the Item selected by the Consumer as well as the information available from the process 0239 indicated as ‘Add to List’ as well as any other information available about the decision by the Consumer to add the Item to a List. The information collected may include: time specific information such the time information on the Item requested, the time when Item added to the List, the time between addition to the List and either deletion or substitution by another product, and the dwell time at the product location; Item specific information such as the description, Brand, Manufacturer, product category, size, packaging dimensions, quantity, weight, color, ingredients, dietary information, usage, and safety information; and indicated affinity by the selection of affinity on Brand, Retailer, or Other Social Media sites.

FIG. 2E shows a process 0241 indicated as ‘Finished Adding Items to the List’. Once the Consumer indicates to the Offer Management Application that they are finished adding items to the list and, the Offer Management Application will send a formatted message requesting a set of Offers from Retailers whom the Consumer has previously selected to shop with the Offer Management Application, identified as a local Retailer, or shown affinity for the Retailer in Social Media. These Offers will be identified and totaled for the Consumer. The Consumer will be able to see the value of the offer, and the estimate of the Shopping Basket may or may not be displayed.

FIG. 2F shows a process 0242 indicated as ‘Consumer Assigns a List to a Retailer’. A List may be blank or contain items. The entire List or a portion of the List may be assigned to a single Retailer. A List or Items need not be assigned to a Retailer before the Consumer begins to shop for items. Once a List is assigned to a Retailer, the List displays open-loop offers valid through that Retailer, closed-loop offers available through that Retailer, and any Digital Loyalty Offers that are valid at that Retailer. A Consumer may choose to reassign the List to any other Retailer at any time.

FIG. 2F shows a process 0243 indicated as ‘Consumer Chooses List to Shop’. The Offer Management Application manages multiple Lists. The Offer Management Application will present the choice of list based upon the latest edited and the geolocation of the Consumer. If a Consumer, the list assigned to a Retailer or any Lists containing Items assigned to a Retailer will be presented prior to other Lists. The Consumer can choose from this display of Lists which they would like to work with. They may use any of the capabilities of the Connected Consumer Device including but not limited to the graphical interface, microphone, touch screen, or keyboard.

FIG. 2F shows a process 0250 indicated as ‘Update Consumer Specific Digital Offer’. As the Consumer begins to shop, or assigns a List to a Retailer, the Offer Management Application passes a formatted message to the Offer Management Server which identifies the Consumer, selected List, Consumer geolocation, and any other meta-data available to the Offer Management Application. The Offer Management Server will evaluate the Consumer qualifications and entitlement to Digital Offers or any appropriate offer, remove Offers that have expired or for which the Consumer is not eligible, and search for any other Offers such as those related to exact product or brand, categorical comparable offers, complementary comparable offers and linked up strategic terms for all items on the list. The Offer Management Server sends a formatted message with the updates, changes, and deletions for the Offers on the List to the Offer Management Application which is retrieved by process 0244 indicated as ‘Display Products on List’ on FIG. 2F.

FIG. 2F shows a process 0244 indicated as ‘Display Products on List’. For each item on the List, the Offer Management Application will show the Consumer each Digital Offer, exact content and offer matches to the exact product or brand, categorical comparable offers, complementary comparable offers, and offers on items related to linked up strategic terms. The Consumer will be able to organize the Offers by those which are Digital Offers, Open Loop Offers, Associated Products including those determined by prior choices and Strategic Linked-up Terms, as well as Competitive Products, and those that are not eligible or where Offers have expired.

FIG. 2F shows a process 0245 indicated as ‘Show Digital Offers’. The Offer Management Application shows a list of all Digital Offers the Consumer has available to them, and the monetary value of the offers based upon the item count on the selected List. The Consumer will indicate their choice of the offer by selecting the offer through the Graphical Interface, keyboard, touch screen, or microphone. Consumers may accept, reject, or ignore any offer.

FIG. 2F shows a process 0246 indicated as ‘Show Open-Loop Offers’. The Offer Management Application shows a list of all Open-Loop Offers the Consumer has available to them, and the monetary value of the offers based upon the item count on the selected List. Open-Loop offers are those offered by Brands but are not specific to a Retailer. The Consumer will indicate their choice of the offer by selecting the offer through the Graphical Interface, keyboard, touch screen, or microphone. Consumers may accept, reject, or ignore any offer.

FIG. 2F shows a process 0247 indicated as ‘Show Offers on Associated Products’. The Offer Management Application shows a list of all Associated Product Offers the Consumer has available to them and the monetary value of the offers based upon the item count, price, and discounted price of each item on the selected List. Associated Products are determined by an analysis by the Offer Management Server which identifies products that the Consumer purchases in relation to a particular item which may or may not appear on the List and items that are Linked-up Strategic Terms. The Consumer will indicate their choice of the offer by selecting the offer through the Graphical Interface, keyboard, touch screen, or microphone. Consumers may accept, reject, or ignore any offer.

FIG. 2F shows a process 0248 indicated as ‘Show Competitive Brand Offers’. The Offer Management Application shows a list of all Competitive Offers the Consumer has available to them, and the monetary value of the offers based upon the item count on the selected List. Competitive Products are: Retailer-specific Offers are valid in the Retailer where the Consumer is located and offered in direct competition with other Brands; those offered from Marketing Affiliates in direct competition with products offered by Brands or Retailers; and Brands that are in direct competition with similar or related products. The Consumer will indicate their choice of the offer by selecting the offer through the Graphical Interface, keyboard, touch screen, or microphone. Consumers may accept, reject, or ignore any offer.

FIG. 2F shows a process 0251 indicated as ‘Consumer Indicated Selected Items in Shopping Basket’. As the Consumer indicates to the Offer Management Application the addition of the Item to the Shopping Basket by using the Graphical Interface, keyboard, touch screen, or microphone to indicate its selection.

FIG. 2F shows a process 0252 indicated as log Product Selection with Meta Data'. All data relative to the Selection of an Item for placement into a Shopping Basket is recorded by the Offer Management Application. Such data may include, but not be limited to, the highest resolution geolocation of the Consumer, the dwell-time of the Consumer at the location, the number of items collected, and any Consumer decision based upon the Offer selection. Using a formatted message, the Offer Management Application forwards this meta-data to the Offer Management Server.

FIG. 2F shows a process 0249 indicated as ‘Consumer Makes Choice’. The Consumer has multiple choices when shown an Item or Offer on the Shopping List: the Consumer may choose to accept, reject, or ignore any type of offer for a Item or they may choose to identify an item the have chosen to place in the Shopping Basket; and they may indicate that they have finished working with this list, and would like to return to process 0226 indicated as Shop for Items on FIG. 2D.

FIG. 2F shows a process 0253 indicated as ‘Offer Management Server Adjusts Offers Based Upon Shopping Activity’. Digital Loyalty Offers value adjusts based upon: (1) Determine Consumers Actual Connected Consumer Device Location in connection to the city they live in via Social Media Site information; (2) where other people within their network are, (3) in proximity (using Social Media Site information including mobile numbers that may be listed), (4) existing members in proximity (both in and outside of Consumers network), (5) determines Consumer demographic data like ones gender, age group or other groups or likes to branded, corporate or associations and group pages (6) scorecards Consumers based on number of friends, frequency at which they post content to the Social Media Site and there posts are responded to by network friends. As these activities take place while the Consumer is shopping, the Offer Management Server will calculate the Digital Offer values on the List, either higher, lower, or no change, as the Consumer indicates their selection of products on the List for inclusion in the Shopping Basket as indicated in process 0248′ Consumer Makes Choice’ on FIG. 2F. Once this determination is made, a formatted message is sent to the Offer Management Application to process 0245 indicated as ‘Show Digital Offers’ on FIG. 2F.

FIG. 2G shows a process 0254 indicated as ‘Connect to Social Media Site with Application’. The Offer Management Application provides connectivity and control of the Social Media site by the Offer Management Application directly.

FIG. 2G shows a process 0255 indicated as ‘Connect to Social Media Site Manually’. The Consumer may open web browsing capable software if the Social Media site does not use software to permit connection of the Offer Management Application or does not permit access by the Offer Management Application on behalf of the Consumer.

FIG. 2H shows a process 0256 indicated as ‘Consumer Edits Master List’. The Offer Management Application communicates with the Offer Management Server to create a Master List of all items purchased by the Consumer. These items are contained in a file on the Offer Management Server and a subset of information is locally stored under the control of the Offer Management Application. As much meta-data regarding the item that can be collected from the Offer Management Application and the Point of Sale at each transaction is aggregated into the Offer Management Server. Management of the Master List includes the ability to add items through the ‘Add Items to Lists’ function 0225 shown in FIG. 2E.

FIG. 2H shows a process 0257 indicated as ‘Consumer Creates Lists’. Consumers have the option to create lists. These lists created are sub-sets of the Master List, however adding an item to a new list does not require the existence of the item on the Master List. New items added to a list but not purchased, will be added to the Master List with meta-data that clearly defines the new item status. Once created, a Consumer will be able to interact with the list through the ‘Add Items to Lists’ function 0225 shown in FIG. 2E.

FIG. 2H shows a process 0258 indicated as ‘Consumer Shares Lists’. Once the Consumer has any List populated in their Offer Management Application, they may choose to share the List with other Consumers. The Offer Management Application will synchronize Lists between the Consumer and any other Consumer they have selected. The synchronization will be coordinated by the Offer Management Server to make sure that Offer Management Application has equivalent items on the List.

FIG. 2I shows a process 0259 indicated as ‘Consumer Identifies Themselves to PoS’. The Consumer will either 1) interact with the application to indicate that they are ready to check out or 2) through location based services on the Connected Consumer Device, the Offer Management Application will determine that they have queued at the Point of Sale System at the Retailer and request confirmation from the Consumer. In both cases, the shopping application will inform the Offer Management Server that the Consumer's basket is complete.

The Consumer can use any of several methods to identify themselves to the Point of Sale (PoS) such as entering their Connected Consumer Device number, phone number, loyalty card or customer number, or any other unique identifier. This information is verified by the Point of Sale and based upon the Consumer's preference set with the Retailer; this information will used to determine if the shopping basket list will be sent to the Redemption Server.

The Offer Management Application will present an estimate of the results of the application of Offer value against the Shopping Basket.

The information required by the Point of Sale to uniquely identify the Consumer has been provided by the Consumer in process 0214 indicated as ‘Consumer Finishes Registration of Application’ on FIG. 2B.

FIG. 2I shows a process 0260 indicated as ‘PoS Requests Offers from Offer Management Server’. The PoS will send a formatted message to the Offer Management Server requesting any Digital Offers and all Items in the Consumer Basket.

FIG. 2I shows a process 0261 indicated as ‘Offer Management Server sends PoS both Offer List & Basket List’. The Offer Management Server will send a formatted message to the Point of Sale a list of Digital Offers and the Items identified by the Consumer as present in the Consumer shopping basket, referred to as the Shopping Basket.

FIG. 2I shows a process 0262 indicated as ‘PoS validates Offer List against Transaction List’. While the Point of Sale is identifying the items in the Shopping Basket through a tally, it will: 1) cross-reference the Items scanned into the Point of Sale against the list of Digital Offers; 2) verify that the Digital Offers meet validity criteria set by the Retailer; 3) Items corresponding to the Offers are found in the Shopping Basket; and 4) Identify Offers that are payable by the Retailer, payable by the Brand, or by either the Retailer or Brand. At the conclusion of the tally, the Point of Sale creates a Validated List.

FIG. 2I shows a process 0263 indicated as ‘PoS Sends Validation to Offer Management Server’. The Point of Sale sends a formatted message to the Offer Management Server that includes a list of Digital Offers that have been validated; would be acceptable to the Retailer; which Offers may be payable by the Brand only, the Retailer only, or either the Brand or Retailer; and any identification information as required to uniquely identify the Consumer. The list may include other information such as items discrepancy: items not scanned by the Offer Management Application but purchased and items scanned by the Offer Management Application but not in Shopping Basket; tally information such as prices, quantity, size, discounted price, final price, and total spend; item identification information such as stock keeping numbers, uniform product codes, or other numerical descriptions; product information such as Brand, product name, manufacturer, or category; as well as any information available to the Point of Sale from the tally of the Shopping Cart.

FIG. 2I shows a process 0264 indicated as ‘Offer Management Server sends Validated Offers to Consumer’. The Point of Sale will show the Consumer the number and value of Digital Offers accepted. The Offer Management Application will receive a formatted message from the Offer Management Server with corresponding information, and present the information to the Consumer.

FIG. 2I shows a process 0265 indicated as ‘Consumer Makes Choice’. Based upon the capability of the Point of Sale to process changes to the transaction, the Consumer may make a choice where the value of the redemption may be applied. The Point of Sale will make a determination in process 0262 indicated as ‘PoS validates Offer List against Transaction List’ shown in FIG. 2I as to which Digital Offers are payable by the Brand only, Retailer only, or either Retailer or Brand. The Consumer can direct the Point of Sale to process the Digital Offer Value as (1) all Digital Offer value applied to the transaction total at the Point of Sale; (2) all Digital Offers payable only at the Retailer and optionally by either the Brand or Retailer to be applied to the transaction at the Point of Sale while all others are directed to a preselected Consumer Account; or (3) all Digital Offers payable only at the Retailer to be applied to the transaction at the Point of Sale while all others are directed to a preselected Consumer Account. Consumer Accounts may include: Retail supported value-holding cards which may hold either points, value, or both; financial-network debit and credit cards; and pre-paid account cards such as financial-network pre-paid cards and gift-cards.

The Offer Management Application will present an estimate of the results of the application of Offer value against the Shopping Basket. Based on this information, the Consumer may make the choice of where the value of the Offer redemption may be applied immediately after they identify themselves to the Point of Sale in process 0259 indicated as ‘Consumer Identifies Themselves to PoS’ as shown on FIG. 2I. If this information is known before the Point of Sale performs a tally of the Shopping Basket, the Point of Sale will appropriate process the Offers as the Items are added in the tally.

FIG. 2I shows a process 0266 indicated as ‘PoS applies valid Offers against Transaction List’. The Point of Sale will apply Offers against the transaction as directed by the Consumer.

FIG. 2I shows a process 0267 indicated as ‘PoS sends Remittance Report to Offer Management Server’. The Point of Sale will send a formatted message of the Advice of Debit against the transaction, Digital Offers, and all information relevant to the transaction. Should the selected Customer Account be the Retail supported value-holding card, the Point of Sale will communicate with the Offer Management Server through application programming interfaces to manage the remittance, redemption, and other accounting.

FIG. 2I shows a process 0268 indicated as ‘PoS sends Offers to Retailer Aggregator who directs Offer Settlement’. The Point of Sale uses the available clearing and Advice of Debit clearing methods for Offers already in place at the Retailer.

FIG. 2I shows a process 0269 indicated as ‘Offer Management Server Applies Remittance to Consumer Accounts’. The Offer Management Server will apply Offers against the transaction as directed by the Consumer by communicating the Advice of Credit directly to the financial Accounts identified by the Consumer.

FIG. 2I shows a process 0270 indicated as ‘Offer Management Server directs Offer Settlement’. The Offer Management Server will direct the Offers against the transaction as directed by the Consumer by communicating the Advice of Debit directly to the Offer Settlement managed services.

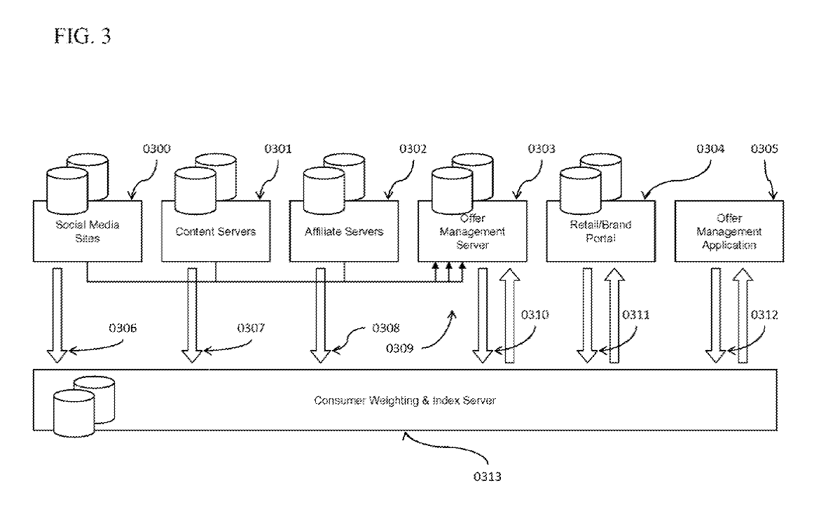

FIG. 3 shows a process 0300 indicated as ‘Social Media Sites’. Social Media Sites include web-based and mobile technologies used to turn communication into interactive dialogue; allow the creation and exchange of Consumer-generated content; and social interaction that can convey identity, conversations, sharing, presence, relationships, reputation, and groups whether a Consumer, Retailer, Brand, or Affiliate. Social Media takes on many different forms including magazines, Internet forums, weblogs, social blogs, microblogging, wikis, podcasts, photographs or pictures, video, rating, and social bookmarking. Social Media technologies may also include: blogs, picture-sharing, voice-logs (vlogs), wall-postings, email, instant messaging, music-sharing, crowdsourcing, and voice-over IP. Social media is also where multiple forms and technologies may be combined to create destinations such as: collaborative projects, blogs and microblogs, content communities, social networking sites, virtual game worlds, and virtual social worlds. These Sites may or may not have information that can be shared through Application Programming Interfaces (API). This information can be used by the process 0313 indicated as ‘Consumer Weighting & Index Server’ on FIG. 3 and by process 0315 indicated as ‘Offer Management Server’ on FIG. 3 and process 0102 indicated as ‘Content Management Server’ on FIG. 1.

FIG. 3 shows a process 0301 indicated as ‘Content Servers’. Content Servers collect, manage, and maintain rich digital content and provide specialized functionality on that content. These servers differ from Social Media Sites in that they are not specialized for participation in a social environment by Consumers nor are they designed for content created by Consumers. These serves may be provided by Retailers or Brands. Their function is to provide content relative to Items, open-loop or closed-loop offers, and where appropriate, demographic, marketing, and Retail performance data. These Sites may or may not have information that can be shared through Application Programming Interfaces (API). This information can be used by the process 0313 indicated as ‘Consumer Weighting & Index Server’ on FIG. 3 and by process 0315 indicated as ‘Offer Management Server’ on FIG. 3 and process 0102 indicated as ‘Content Management Server’ on FIG. 1.

FIG. 3 shows a process 0302 indicated as ‘Affiliate Servers’. Affiliate Servers is a tool used by an Affiliate Marketer in their business of being rewarded by one or more Brand or Retailer for each visitor or customer brought about by the affiliate's own marketing efforts. Their function is to provide content relative to Items, open-loop offers or closed-loop, and where appropriate, demographic, marketing, and Retail performance data. These Sites may or may not have information that can be shared through Application Programming Interfaces (API). This information can be used by the process 0313 indicated as ‘Consumer Weighting & Index Server’ on FIG. 3 and by process 0315 indicated as ‘Offer Management Server’ on FIG. 3 and process 0102 indicated as ‘Content Management Server’ on FIG. 1.

FIG. 3 shows a process 0303 indicated as ‘Offer Management Server’. The Offer Management Server contains a data base of shopping information collected by (1) the Offer Management Application, which includes Offers prepared for Consumers by Brands, Retailers, and Marketing Affiliate Agents, (2) Predictive Social Behavior calculated on Consumer activity, (3) Remarketability of indexed Consumer data analytics, and (4) Offer selection algorithms which operate under rules established by the Offer owner. These rules could include minimum and maximum redemption offers, time, offer duration, location valid, specific Retailer valid locations, and other terms and conditions as determined important by the offer owner. As the Consumer makes selections and adds them to the Offer Management Application, the Offer Management Server will make offers which are relative to the items chosen to the Consumer. Should there be items in the Consumer basket that are not on the shopping list, the Offer Management Server will determine which offers the Consumer may be eligible and add these offers to the Offer Management Application automatically for presentation to the Consumer. The Offer Management Server can communicate to the Social Media Site, which is shown as item 0103 in FIG. 1 and to the Connected Consumer Device, which is shown as item 0101 in FIG. 1. This information can be used by the process 0313 indicated as ‘Consumer Weighting & Index Server’ on FIG. 3.

FIG. 3 shows a process 0304 indicated as ‘Retail/Brand Portal’. The Retail/Brand portal is a Web site that functions as an entry point to process 0315 indicated as ‘Offer Management Server’ on FIG. 3 and process 0102 indicated as ‘Content Management Server’ on FIG. 1. The portal will enable brands to edit content, submit new content (static and or video), and offers that will only become valid through an approval process. The Retail/Brand Portal includes the ability to add 2D bar codes for specific items or promotions and in-store, to provide Digital Offers which will appear on the branded Social Media Site, and which may have whatever time-limit and supply-limits. The Brand or Retailer will have controls to set content and offers which would be made available and seen by the Consumer from the perspective of the Offer Management Application as they search within, build the shopping list, and providing suggestive offers which based on the rules engine that links strategic terms. The rules engine for linked strategic terms is based on the Offer Management Server which is shown as item 0103 in FIG. 1. The Retail/Brand Portal communicates and shares information as needed by the process 0313 indicated as ‘Consumer Weighting & Index Server’ on FIG. 3 and by process 0315 indicated as ‘Offer Management Server’ on FIG. 3 and process 0102 indicated as ‘Content Management Server’ on FIG. 1.

FIG. 3 shows a process 0305 indicated as ‘Offer Management Application’. The Offer Management Application is a software application which runs on the Connected Consumer Device which is shown as item 0101 in FIG. 1. The Offer Management Application is focused on how Consumers shop by collecting, tracking, and indexing: knowledge of intent by creation of shopping lists; substitution of items on list basis offers; report on intent and sales across channel, category, brand, and product; measure market basket size, spend, and uplift; and offer presentation, load, and redemption. The Offer Management Application measures and indexes how Consumers share information: sharing a list with a significant other by writing a list then sharing with a second who may do the shopping and their history and preference and offers from first is carried over to second; and new items added by second, become part of the history of the second. The Offer Management Application also indexes and measures sharing through Social Media by allowing Social Media Site credentials as identity; captures name, phone no., email, and automatically posts announcements on Social Media Sites; Brand and Retail may use Social Media Sites to announce inducements of significant value and new member can download Offer Management Application to redeem inducement and offers of interest to Consumer can be posted on Social Media Sites, others who wish to use the offer as well, can download Offer Management Application to redeem inducement. The Offer Management Application communicates and shares information as needed by the process 0313 indicated as ‘Consumer Weighting & Index Server’ on FIG. 3 and by process 0315 indicated as ‘Offer Management Server’ on FIG. 3.

FIG. 3 shows a process 0306 indicated as ‘Direct Connection to Social Media Sites through API’. An application programming interface (API) is a defined set of request messages along with a definition of the structure of the response messages. The defined messages are used to simplify communication between the process 0313 indicated as ‘Consumer Weighting & Index Server’ on FIG. 3 and by process 0300 indicated as ‘Social Media Sites’ on FIG. 3 and to define the scope of content, activity, and other information which can be used for acquisition, registration, measurement and indexing individual and network metrics by the process 0313 indicated as ‘Consumer Weighting & Index Server’ on FIG. 3.

FIG. 3 shows a process 0307 indicated as ‘Direct Connection to Social Media Sites through API’. An application programming interface (API) is a defined set of request messages along with a definition of the structure of the response messages. The defined messages are used to simplify communication between the process 0313 indicated as ‘Consumer Weighting & Index Server’ on FIG. 3 and by process 0301 indicated as ‘Content Servers’ on FIG. 3 and to define the scope of content, activity, and other information which can be used for acquisition, registration, measurement and indexing individual and network metrics by the process 0313 indicated as ‘Consumer Weighting & Index Server’ on FIG. 3.

FIG. 3 shows a process 0308 indicated as ‘Direct Connection to Social Media Sites through API’. An application programming interface (API) is a defined set of request messages along with a definition of the structure of the response messages. The defined messages are used to simplify communication between the process 0313 indicated as ‘Consumer Weighting & Index Server’ on FIG. 3 and by process 0302 indicated as ‘Affiliate Servers’ on FIG. 3 and to define the scope of content, activity, and other information which can be used for acquisition, registration, measurement and indexing individual and network metrics by the process 0313 indicated as ‘Consumer Weighting & Index Server’ on FIG. 3.

FIG. 3 shows a process 0309 indicated as ‘Indirect Connection to Social Media, Content, and Affiliate Servers’. When an application programming interface (API), a defined set of request messages along with a definition of the structure of the response messages, is not available, the system identified as 0303 as ‘Offer Management Server’ on FIG. 3 will use specifically crafted communication systems to collect content, activity, and other information which can be used for acquisition, registration, measurement and indexing individual and network metrics by the process 0313 indicated as ‘Consumer Weighting & Index Server’ on FIG. 3.

FIG. 3 shows a process 0310 indicated as ‘Database Information Exchange through API’. An application programming interface (API) is a defined set of request messages along with a definition of the structure of the response messages. The defined messages are used to simplify communication between the process 0313 indicated as ‘Consumer Weighting & Index Server’ on FIG. 3 and by process 0303 indicated as ‘Offer Management Server’ on FIG. 3 and to define the scope of content, activity, and other information which can be used for acquisition, registration, measurement and indexing individual and network metrics by the process 0313 indicated as ‘Consumer Weighting & Index Server’ on FIG. 3.

FIG. 3 shows a process 0311 indicated as ‘Database Information Exchange through API’. An application programming interface (API) is a defined set of request messages along with a definition of the structure of the response messages. The defined messages are used to simplify communication between the process 0313 indicated as ‘Consumer Weighting & Index Server’ on FIG. 3 and by process 0304 indicated as ‘Retail/Brand Portal’ on FIG. 3 and to define the scope of content, activity, and other information which can be used for acquisition, registration, measurement and indexing individual and network metrics by the process 0313 indicated as ‘Consumer Weighting & Index Server’ on FIG. 3.

FIG. 3 shows a process 0312 indicated as ‘Database Information Exchange through API’. An application programming interface (API) is a defined set of request messages along with a definition of the structure of the response messages. The defined messages are used to simplify communication between the process 0313 indicated as ‘Consumer Weighting & Index Server’ on FIG. 3 and by process 0305 indicated as ‘Offer Management Application’ on FIG. 3 and to define the scope of content, activity, and other information which can be used for acquisition, registration, measurement and indexing individual and network metrics by the process 0313 indicated as ‘Consumer Weighting & Index Server’ on FIG. 3.

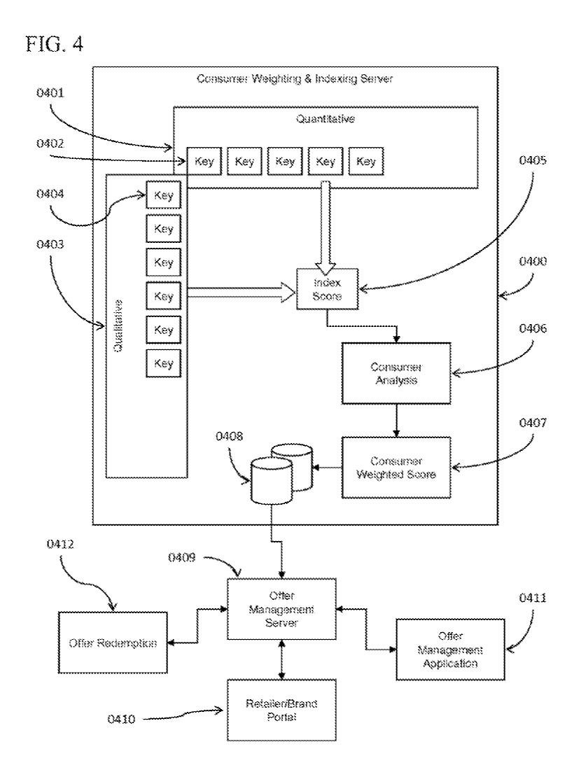

FIG. 3 shows a process 0313 indicated as ‘Consumer Weighting & Index Server’. The Consumer Weighting & Index Server employs weighted customizable categorical metrics to each of the below areas that provide functional behavioral data enabling through: (1) Connecting, integrating, capturing and indexing an individuals social media behavioral data (and their networks behavior); (2) Connectivity, integration, capturing and indexing individual behavioral data (and their networks' behavior) in relation to Point of Intent computer software (such as an Application or connectivity within) to a Connected Consumer Device (connected through Internet protocol such as a smartphone, tablet, set top box, automobile, etc.); and (3) Connectivity, integration, capturing and indexing data from a Consumer prompted Point of Recognition (redeemed, benefited and or monetized at a physical point of sale (such as a cash register within a physical Retail store). The above three databases are thereafter measured through a relational database described as “Relational Content” which indexes behavioral data from social, to Point of Intent to Point of Recognition with weighted customizable categorical acquisition, registration, measurement and indexing individual and network metrics. The corresponding data of each individual database or through “Relational Context” is intended to deliver an individual more personalized desired content that is funneled by and through a Consumer's digital and physical behaviors. The behavior of process is shown in more detail by FIG. 4.

FIG. 3 shows a process 0314 indicated as ‘Offer Redemption’. The Consumer may, through the Offer Management Application and the Offer Management Server, direct the Point of Sale to process the Digital Offer Value as: (1) all Digital Offer value applied to the transaction total at the Point of Sale; (2) all Digital Offers payable only at the Retailer and optionally by either the Brand or Retailer to be applied to the transaction at the Point of Sale while all others are directed to a preselected Consumer Account; or (3) all Digital Offers payable only at the Retailer to be applied to the transaction at the Point of Sale while all others are directed to a preselected Consumer Account. Consumer Accounts may include: Retail supported value-holding cards which may hold either points, value, or both; financial-network debit and credit cards; and pre-paid account cards such as financial-network pre-paid cards and gift-cards.

FIG. 4 shows a process 0400 indicated as ‘Consumer Weighting & Indexing Server’. The Consumer Weighting & Index Server employs weighted customizable categorical metrics to each of the below areas that provide functional behavioral data enabling through: (1) Connecting, integrating, capturing and indexing an individuals social media behavioral data (and their networks behavior); (2) Connectivity, integration, capturing and indexing individual behavioral data (and their networks' behavior) in relation to Point of Intent computer software (such as an Application or connectivity within) to a Connected Consumer Device (connected through Internet protocol such as a smartphone, tablet, set top box, automobile, etc.); and (3) Connectivity, integration, capturing and indexing data from a Consumer prompted Point of Recognition (redeemed, benefited and or monetized at a physical point of sale (such as a cash register within a physical Retail store). The above three databases are thereafter measured through a relational database described as “Relational Content” which indexes behavioral data from social, to Point of Intent to Point of Recognition with weighted customizable categorical acquisition, registration, measurement and indexing individual and network metrics.

Activity by the Consumer will result in the identification of data, meta-data, and other elements that are quantitative in nature. The distribution of these elements relative to all of the other Consumers will result in qualitative scores for the elements. The comparison of the quantitative and qualitative values will present an index score for each of the elements for each Consumer.

The resulting Index Score is run through a Consumer Analysis which makes an adjusted valuation of the Consumer, positioning the Consumer through categorical typing to create an aggregated Customer Weighted Score. These Scores are relative to the probability of the Consumer to make a reaction or predict or understand their intention.

These Consumer Weighted Scores are stored in a database to provide easy access to the Offer Management Server which in turn will enable the Retailer/Brand Portal to adjust Digital Offers for the Consumer as they are shopping.

FIG. 4 shows a process 0401 indicated as ‘Quantitative’. The Consumer Weighting & Indexing Server, indicated as process 0313 on FIG. 3 and process 0401 on FIG. 4, communicates with multiple servers as indicated in FIG. 3. These communications collect data, metadata, and other elements which are tabulated as counts, events, and other quantitative data for each Consumer.

FIG. 4 shows a process 0402 indicated as ‘Key’ is a Quantitative Key Index Record. This record is identified with a specific Consumer quantitative data element as part of process 0401 indicated as ‘Quantitative’ on FIG. 4.

FIG. 4 shows a process 0403 indicated as ‘Qualitative’. The Consumer Weighting & Indexing Server, indicated as process 0313 on FIG. 3 and process 0401 on FIG. 4, communicates with multiple servers as indicated in FIG. 3. Activity by the Consumer will result in the identification of data, meta-data, and other elements that are quantitative in nature. The distribution of these elements relative to all of the other Consumers will result in qualitative scores for the elements.

FIG. 4 shows a process 0404 indicated as ‘Key’ is a Qualitative Key Index Record. This record is identified with activity, event, or other data showing the range, distribution, and other quantitative data values as part of process 0401 indicated as ‘Quantitative’ on FIG. 4.

FIG. 4 shows a process 0405 indicated as ‘Index Score’. Comparison of activity by the Consumer against and related Qualitative Key Element Records will present an Index Score for both the quantitative and qualitative elements for each Consumer. These scores will be maintained in a database, accessible by process 0406 identified as ‘Consumer Analysis’ shown on FIG. 4.

FIG. 4 shows a process 0406 indicated as ‘Consumer Analysis’. The process Consumer Analysis adjusts valuations of the Consumer Index Score, positioning the Consumer through categorical typing to determine the probability of the Consumer to make a reaction or predict or understand their intention with regard to incentives, offers, or loyalty to Brands, Retailers, or Items.

FIG. 4 shows a process 0407 indicated as ‘Consumer Weighted Score’. Consumer Analysis makes an adjusted valuation of the Consumer, positioning the Consumer through categorical typing to create an aggregated Customer Weighted Score. These scores aggregate Consumers into large groups who would exhibit behaviors that have strong similarities and would be expected to react the same way given incentives, offers, or with loyalty to particular Brands, Retailers, or Items.

FIG. 4 shows a process. The results of process 0406 indicated as ‘Consumer Analysis’ indicated as on FIG. 4 and process 0407 indicated as ‘Consumer Weighted Score’ on FIG. 4 are stored in a database indicated by process 0408.

FIG. 4 shows a process 0409 indicated as ‘Offer Management Server’. The Offer Management Server accesses the database indicated as process 0408 on FIG. 4 to gain access to the results of Index Score, Consumer Analysis, and the Consumer Weighted Score. The Offer Management Server uses these scores along with instructions set by the Retail/Brand Portal construct Digital Offers for use by the Offer Management Application as well as the Retail and Brand Social Media Sites.

FIG. 4 shows a process 0410 indicated as ‘Retailer/Brand Portal’. The Retailer/Brand Portal communicates with the Offer Management Server to select Consumers based upon their Consumer Weighting & indexing Server scoring.

FIG. 4 shows a process 0411 indicated as ‘Offer Management Application’. The Offer Management Application communicates with the Offer Management Server to retrieve the Digital Offers set through the Retail/Brand Portal, and to provide information to Offer Management Server which will forward it to the Consumer Weighting & Indexing Server for adding to and adjusting the Consumer data.

Embodiments of the invention provide for complete access to membership registration either from social media to a Connected Consumer Device or a Connected Consumer Device alone and, in doing so unlocking access to membership and customized offers.

Embodiments of the invention further provide for authenticating a Consumer by either showing affinity or joining a social media Fan, Group, Brand, Association or other group in connection with computer software (an application that rests on a connected device such as a smartphone) that uses social media Consumer identity and password to confirm or automatically showing affinity or joining a social media Fan, Group, Brand, Association, or other group.

Embodiments of the invention further provide for authenticating a Consumer of a mobile application with and through their social networks by the Consumer opting into a group or showing affinity to a fan page or by: (1) social networks (2) authenticating a Consumer originating from the mobile application that uses the social networks Consumer name and password and automatically showing affinity to a brand or fan page or group or has previously shown affinity to a fan page or group. (3) If showing affinity to a fan page or group initially prompted on the Social Media Site in and of itself; completed authentication occurs when the Consumer completes registration by downloading application and thereafter, enters social media web site Consumer name and password.

In accordance with an embodiment of the invention, in connection to all features and functionalities of mobile use of the offer management application viewing all social available data such as: (1) determine Consumers actual Connected Consumer Device location in connection to the city they live in via Social Media Site information; (2) where other people within their network are, (3) in proximity (using Social Media Site information including mobile numbers that may be listed), (4) existing members in proximity (both in and outside of Consumers network), (5) determines Consumer demographic data like ones gender, age group or other groups or likes to branded, corporate or associations and group pages (6) scorecards Consumers based on number of friends, frequency at which they post content to the Social Media Site and there posts are responded to by network friends.

Embodiments of the invention further provide for reviewing existing members and common friends so that friends can be suggested to other friends in the confines of a social media or application suggestion engine based upon a Consumers demonstrate affinity for a social media Fan, Group, Brand, Association or other type of pages (social media destination) that endeavors to build product, brand, group or association affinity.

In accordance with an embodiment of the invention, a Consumer has the ability to add a suggested another to their account so that, in way of example but not limitation, a husband and wife can share an experience under engagement, yet remain two unique Consumers by having unique credentials as demarcation. Such unique credentials can include social media behavioral characteristics such as (1) network data: total network location in connection to Consumer, gender, age (ranges), children, animals, etc. regional events; (2) personality traits: number of friends, by gender, by location, in location (region), similar traits; and (3) Social Voice: frequency of updates, comments, and demonstration of affinity.

Embodiments of the invention further provide for using human voice interaction in connection to voice recognition software that converts human words into a database establishing the spoken words and comparing and contrasting those words to exact content and offer matches to the exact product or brand, categorical comparable offers, complementary comparable offers and linked up strategic terms that search a database that has predetermined products features and functionalities that enable simplified searching to the Consumers query.

In accordance with an embodiment of the invention, internet accessible web portals that businesses such as Brands or Retailers may provide content and offers are digitally connected from social media Fan, Group, Brand, Association or other group pages and connected to computer software (such as an application that rests on a connected device such as a smartphone) that connects the earned offers to a point of sale system through methods such as: (1) directly through a Retailers point of sale system; (2) in connection to a Retailers loyalty card program that provides a ‘load to card’ functionality; (3) in connection to a certain financial or coupon clearing house/processor; (4) in connection to and in direct association to a specific payment source such as credit card networks; (5) social customer relation management: views past, present and future acceptance to a Digital Offer as well as past purchases or demonstrate affinity for of social media Fan, Group, Brand, Association or other groups; and (6) demographic profiles centered around social communication.

In accordance with an embodiment of the invention, a Digital Offer made available to the Consumer through the social media presence is conditional based upon: the use of an application on a smart Connected Consumer Device; synchronization of social medial activity between the application, offer management server, and social media presence; valid identification of the Consumer; and purchase history, location, and deductive analytics.

In accordance with an embodiment of the invention Digital Offers are made available to the Consumer based upon the analysis of Consumer engagement, intent, and interest in Retailers, brand, products, or services. Engagement by the Consumer may be shown through subscription to content from Social Media Sites; expression on a Social Media Site of a Retailer, brand, product, or service as preferred; expressing affinity on a Social Media Site for a Retailer, brand, product, or service; purchase of a product or service; and the addition of a service or product to a list on a Connected Consumer Device; or the results of operant conditioning analysis.

In accordance with an embodiment of the invention, a method for distributing digital offers is provided, comprising the steps of (1) providing an offer management server that executes on one or more microprocessors, wherein the offer management server is adapted to communicate with an offer management application on a computing device, (2) receiving, at the offer management server, an indication of a particular viewed item, (3) determining a digital offer based on the particular viewed item, and, (4) communicating the digital offer from the offer management server to the offer management application.

In accordance with another embodiment of the invention, a system for distributing digital offers is provided, comprising (1) an offer management server that executes on one or more microprocessors, wherein the offer management server is adapted to communicate with an offer management application on a computing device, (2) wherein the offer management server receives an indication that the offer management application viewed a particular item, wherein the offer management server determines, based on the particular viewed item, a digital offer, and (3) wherein the offer management server communicates the digital offer to the offer management application to be redeemed at a point of sale.

In accordance with still another embodiment of the invention, a non-transitory computer readable storage medium is provided for storing one or more sequences of instructions for distributing digital offers is provided. The instructions, when executed by one or more processors, cause the one or more processors to execute the steps of (1) providing an offer management server that executes on one or more microprocessors wherein the offer management server is adapted to communicate with an offer management application on a computing device, (2) receiving, at the offer management server, an indication of a particular viewed item (3) determining a digital offer based on the particular viewed item and (4) communicating the digital offer to the offer management application.

Another embodiment includes a method for distributing digital offers, comprising the steps of (1) providing an offer management application that executes on one or more microprocessors on a computing device, (2) communicating, from the offer management application, a particular viewed item to an offer management server, wherein the offer management server is adapted to determine whether the particular viewed item, a digital offer, and (4) receiving the digital offer at the offer management application.

And yet another embodiment includes a system for distributing digital offers, comprising (1) an offer management application that executes on one or more microprocessors on a computing device, (2) wherein the offer management application is adapted to communicate an indication that the offer management application viewed a particular item to an offer management server (3) wherein the offer management server determines bandwidth of the particular viewed item, a digital offer and (4) wherein the offer management application receives the digital offer.

The present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium or computer readable medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method for distributing digital offers, comprising the steps of:
providing an offer management server that executes on one or more microprocessors, wherein the offer management server is adapted to communicate with an offer management application on a computing device, and wherein the offer management application includes an application identification tag and an activity log,
wherein the application identification tag uniquely identifies the offer management application, and
wherein the activity log includes one or more viewed items;
receiving, at the offer management server, an indication of a particular viewed item from the one or more viewed items and the activity log;
determining a digital offer based on the application identification tag, the particular viewed item, and the activity log; and
communicating the digital offer from the offer management server to the offer management application.

2. The method of claim 1, further comprising:
communicating social media behavioral data to the offer management server, wherein when the offer management application communicates with one or more social media sites, the one or more social media sites collect and communicate the social media behavioral data to the offer management server;
determining, based on the particular viewed item, the activity log, and the social media behavioral data, another digital offer; and
communicating the another digital offer to the offer management application.

3. The method of claim 2, further comprising:
generating, at the offer management server, a social media behavioral data metric, a particular viewed item metric, and a digital offer metric, wherein each metric includes a predefined weight;
determining an index score for the offer management application based on the social media behavioral data metric, the particular viewed item metric, and the digital offer metric; and
providing the index score to a consumer analysis component at the offer management server to adjust a valuation associated with the offer management application, wherein the valuation is used to generate additional digital offers.

4. The method of claim 2, further comprising:
providing digital offers to the offer management application based on one of a subscription to products at the one or more social media sites, a list of products communicated from the offer management application to the offer management server, and a location of the offer management application.

5. The method of claim 2, further comprising:
receiving, at the offer management server, an indication of a request for a digital offer at a particular social media site, wherein based on the indication of the request and the activity log, a digital offer is determined; and
communicating the digital offer to the offer management application by the offer management server.

6. The method of claim 1, further comprising:
receiving, at the offer management server, an indication that the digital offer has been shared with other offer management applications, wherein sharing the digital offer creates a shared activity log that indicates the sharing of the digital offer; and
receiving, at the offer management server, shared activity logs from the one or more participating offer management applications.

7. The method of claim 6, further comprising:
associating the shared activity log with the offer management application by the offer management server; and
using, by the offer management server, the shared activity log associated with the offer management application, the activity log, and the shared activity logs from the one or more participating offer management applications to generate other digital offers for the offer management application.

8. The method of claim 1, further comprising:
receiving a location of the offer management application at the offer management server;
comparing, at the offer management server, the location of the offer management application to a database of locations;
generating, based on the comparison, a list of available stores;
receiving, at the offer management server, a selection of one of the available stores from the list of available stores; and
communicating, based on the selection, one or more digital offers to the offer management application from the offer management server.

9. The method of claim 2, further comprising:
generating, at the offer management server, a score card based on the social media behavioral data and registration information associated with the offer management application; and
generating, at the offer management server, other digital offers based on the social media behavioral data and the score card.

10. The method of claim 1, further comprising receiving, at the offer management server, an indication that the digital offer has been redeemed at a point of sale.

11. A system for distributing digital offers, comprising:
an offer management server that executes on one or more microprocessors, wherein the offer management server is adapted to communicate with an offer management application on a computing device, and wherein the offer management application includes an application identification tag and an activity log,
wherein the application identification tag uniquely identifies the offer management application, and
wherein the activity log includes one or more viewed items from the one or more viewed items;
wherein the offer management server receives the activity log and an indication that the offer management application viewed a particular item from the one or more viewed items, wherein the offer management server determines, based on the application identification tag, the particular viewed item, and the activity log, a digital offer; and
wherein the offer management server communicates the digital offer to the offer management application to be redeemed at a point of sale.

12. The system of claim 11, wherein the offer management server is adapted to receive social media behavioral data from one or more social media sites; and
wherein the offer management server determines, based on the particular viewed item, the activity log, and the social media behavioral data, another digital offer.

13. The system of claim 12, wherein the offer management server:
generates a social media behavioral data metric, a particular viewed item metric, and a digital offer metric, wherein each metric includes an predefined weight;
determines, based on the social media behavioral data metric, the particular viewed item metric, and the digital offer metric, an index score for the offer management application; and
provides the index score to a consumer analysis component to adjust a valuation associated with the offer management application, wherein the valuation is used to generate additional digital offers.

14. The system of claim 12, wherein the offer management server provides digital offers to the offer management application based on one of a subscription to products at the one or more social media sites, a list of products communicated from the offer management application to the offer management server, and a location of the offer management application.

15. The system of claim 12, wherein the offer management server receives an indication of a request for a digital offer provided at a particular social media site, wherein based on the indication of the request and the activity log, a digital offer is determined; and
wherein the offer management server communicates the digital offer to the offer management application.

16. The system of claim 11, wherein the offer management server receives an indication that the digital offer has been shared with other offer management applications, and wherein sharing the digital offer creates a shared activity log that indicates the sharing of the digital offer; and
wherein the offer management server receives shared activity logs from the one or more participating offer management applications.

17. The system of claim 16, wherein the offer management server:
associates the shared activity log with the offer management application; and
uses the shared activity log associated with the offer management application, the activity log, and the shared activity logs from the one or more participating offer management applications to generate other digital offers for the offer management application.

18. The system of claim 11, wherein when the offer management server receives a location of the offer management application, the offer management server
compares the location of the offer management application to a database of locations, and based on the comparison,
provides the offer management application a list of available stores; and
wherein when a selection of one of the available stores from the list of available stores is received at the offer management server, the offer management server communicates one or more digital offers to the offer management application.

19. The system of claim 12, wherein the offer management server generates a score card based on the social media behavioral data and registration information associated with the offer management application, and wherein other digital offers are generated based on the social media behavioral data and the score card.

20. A non-transitory computer readable storage medium storing one or more sequences of instructions for distributing digital offers, wherein said instructions, when executed by one or more processors, cause the one or more processors to execute the steps of:
providing an offer management server that executes on one or more microprocessors, wherein the offer management server is adapted to communicate with an offer management application on a computing device, and wherein the offer management application includes an application identification tag and an activity log,
wherein the application identification tag uniquely identifies the offer management application, and
wherein the activity log includes one or more viewed items;
receiving, at the offer management server, an indication of a particular viewed item from the one or more viewed items and the activity log;
determining a digital offer based on the application identification tag, the particular viewed item, and the activity log; and
communicating the digital offer from the offer management server to the offer management application.

21. A method for distributing digital offers, comprising the steps of:
providing an offer management application that executes on one or more microprocessors on a computing device, wherein the offer management application includes an application identification tag and an activity log,
wherein the application identification tag uniquely identifies the offer management application, and
wherein the activity log includes one or more viewed items;
communicating, from the offer management application, a particular viewed item from the one or more viewed items and the activity log to an offer management server, wherein the offer management server is adapted to determine, based on the application identification tag, the particular viewed item, and the activity log, a digital offer; and
receiving the digital offer at the offer management application.

22. A system for distributing digital offers, comprising:
an offer management application that executes on one or more microprocessors on a computing device, and wherein the offer management application includes an application identification tag and an activity log,
wherein the application identification tag uniquely identifies the offer management application, and
wherein the activity log includes one or more viewed items from the one or more viewed items;
wherein the offer management application is adapted to communicate the activity log and an indication that the offer management application viewed a particular item to an offer management server, wherein the offer management server determines, based on the application identification tag, the particular viewed item, and the activity log, a digital offer; and
wherein the offer management application receives the digital offer.
